(19) United States
(12) Patent Application Publication
(10) Pub. No.: US 2025/0289983 A1
(43) Pub. Date: Sep. 18, 2025

(54) Glitter Glue Stick and Its Preparation Method

(71) Applicant: Ningbo Pasco United Industry Co., Ltd., Yuyao City (CN)

(72) Inventor: Xiaohua QIAN, Yuyao City (CN)

(73) Assignee: Ningbo Pasco United Industry Co., Ltd., Yuyao City (CN)

(21) Appl. No.: 18/609,615

(22) Filed: Mar. 19, 2024

(30) Foreign Application Priority Data
Mar. 12, 2024 (CN) 2024102761157

(51) Int. Cl. C09J 9/00; C09J 11/04; C09J 11/06; C09J 11/08; C09J 139/06

(52) U.S. Cl. CPC C09J 9/005; C09J 11/04; C09J 11/06; C09J 11/08; C09J 139/06

(57) ABSTRACT

A glitter glue stick and its preparation method. The glitter glue stick comprises the components with the following weight percentage content: 20%˜60% deionized water, 3%˜20% propylene glycol, 10%˜40% glycerin, 15%˜30% adhesive, 0%˜1% defoamer, 1%˜10% excipient, 0.5% ˜2% caustic soda, 0.1%˜0.5% preservative, 0%˜0.3% pigment and 1% ˜10% glitter; the PH value of the glitter glue stick prepared by the present invention is 10.0 to 11.0. After gluing on the paper, the glitter powder can be uniformly and densely distributed on the gluing surface, displaying different colors and glitter effects. The drying time is controllable, and it has a strong adhesive force after completely drying.

### INCORPORATION BY REFERENCE

This application claims priority to CN Application No. 2024102761157, filed Mar. 12, 2024, which is hereby incorporated by reference.

### FIELD OF TECHNOLOGY

The present invention relates to the field of adhesive technology, in particular to a glitter glue stick and a preparation method thereof.

### BACKGROUND TECHNOLOGY

Most of the glue stick sold on the market are solid water-based adhesives that use one or more materials such as polyvinyl alcohol, polyvinylpyrrolidone, acrylic resin, vinyl acetate resin, and starch as adhesive, and use fatty acid salt as the excipient. Most of their appearance is cylindrical, and some of them are rectangular or triangular. The glue stick has the advantages of long storage period, convenient carrying, easy use and strong bonding.

At present, the PVA glue stick on the market is prepared through condensation reaction with formaldehyde, and then by adding sodium hydroxide and high fatty acid for saponification reaction. Its appearance is white solid and it contains formaldehyde. For example, the glue stick made in the patent “Solid Adhesive and Its Preparation Method” with the application number of 201310436284.4 was prepared by direct heating and dissolution of starch or stickum, and saponification reaction of sodium hydroxide and higher fatty acid; it is white solid in appearance. Another example is the transparent glue stick prepared by the patent “Transparent Glue Stick and Its Preparation Method” with application number 201610412219.1 which was prepared by direct heating and dissolution of polyvinylpyrrolidone, and saponification reaction of sodium hydroxide and higher fatty acid; it is colorless or yellow transparent solid in appearance. This kind of glue stick is basically white or colored or transparent glue stick. That is, it has too limited colors and is not attractive enough for children.

In view of this, the present invention is specially proposed.

### CONTENTS OF THE INVENTION

The first purpose of the present invention is to provide a glitter glue stick, which has the characteristics of color diversity, bright appearance and environmental friendliness, has better interestingness, has higher appeal to children, and can better meet market demand.

The second purpose of the present invention is to provide a preparation method of glitter glue stick. The preparation method of the invention makes the prepared glitter glue stick have better appearance, shining and coating effect through the control of specific technology and parameters.

In order to serve the above purposes of the present invention, the following technical solutions are specially adopted:

In a first aspect, the present invention provides a glitter glue stick, which comprises the components with the following weight percentage content:

20%˜60% deionized water, 3%˜20% propylene glycol, 10%˜40% glycerin, 15%˜30% adhesive, 0%˜1% defoamer, 1%˜10% excipient, 0.5%˜2% caustic soda, 0.1%˜0.5% preservative, 0%˜0.3% pigment and 1% ˜10% glitter.

Preferably, the adhesive is selected from at least one of polyvinylpyrrolidone, starch and acrylic resin.

Preferably, the defoamer is a water-soluble polyether defoamer.

Preferably, the excipient is a fatty acid with a carbon atom number of 12 to 18.

Preferably, the excipient is a mixed solution of stearic acid, palmitic acid and lauric acid.

Preferably, the preservative is a BIT-type preservative.

In the present invention, the types of pigment and glitter are not strictly restricted, and technicians in the field can make routine selection according to actual needs. Preferably, in order to improve environmental friendliness and safety, the pigment can be food color or toner that meet the requirements of cosmetics regulations; preferably, the glitter can have laser effects.

In a second aspect, the present invention provides a preparation method for glitter glue stick, which comprises the following steps:

(a) Immerse the glitter in the silane coupling agent solution and remove and dry it for later use; dissolve the caustic soda in partially deionized water to obtain caustic soda solution for later use;

(b) Add glycerol and propylene glycol to the remaining deionized water and stir well to obtain the first mixed solution;

(c) Under stirring conditions, add the adhesive and part of the defoamer to the first mixed solution and continue stirring for a certain period of time, then heat the mixed solution and continue stirring until the adhesive is completely dissolved. Then add the remaining defoamer and excipient and stir until they are completely dissolved to obtain the second mixed solution;

(d) Add the caustic soda solution to the second mixed solution for saponification reaction. After the end of the reaction, under the condition of heat preservation, then add the preservatives and pigments in turn and stir well, and leave to defoam, to obtain the third mixed solution;

(e) Add the glitter to the third mixed solution and stir well to obtain the said glitter glue stick.

Preferably, the silane coupling agent solution concentration is 0.5% to 1%.

Preferably, in step (a) described, the concentration of the sodium hydroxide solution is 15% to 25%.

Preferably, the heating temperature in step (c) described is 80 to 90° C.

Preferably, the addition of sodium hydroxide solution to the second mixed solution for the saponification reaction in step (d) consists of: adding sodium hydroxide solution to the second mixed solution under stirring conditions at 80 to 90° C. and continuing the stirring reaction for 30 to 40 min.

Compared with the existing technology, the beneficial effects of the invention include at least:

By adjusting the composition ratio of glycerin, propylene glycol and excipient, the present invention can adjust the appearance glittering effect of the specified glitter, so that it presents different degrees of three-dimensional effect, and can adjust the initial sticking time and complete drying time after the glitter glue stick is applied to the adhesive; in addition, through selection of pigments and glitter type and added amount limit, the appearance color effect of glitter glue stick can be adjusted. Besides, through the treatment of glitter, the alkaline resistance, solvent resistance, and water resistance of the glitter have a certain degree of improvement compared with ordinary glitter. It can be stable for a long time under the alkaline and high temperature conditions of the preparation of glitter glue stick and the alkaline conditions of the finished glitter glue stick, without the abnormal phenomena of fading or color disappearance.

The PH value of the glitter glue stick prepared by the present invention is 10.0 to 11.0. After gluing on the paper, the glitter powder can be uniformly and densely distributed on the gluing surface, displaying different colors and glitter effects. The drying time is controllable, and it has a strong adhesive force after completely drying. The raw materials and added amount adopted meet the requirements of the toy standard, which is safe and environmentally friendly. And the prepared glitter glue stick has excellent storage stability.

### EMBODIMENT

Embodiments of the technical solution of the present invention will be described in detail below in connection with the embodiments. The following embodiments are intended only to illustrate more clearly the technical solution of the present invention, and are therefore intended only as examples, and not as such to limit the scope of protection of the present invention.

It is to be noted that, unless otherwise specified, technical or scientific terms used in this application shall have the ordinary meaning as understood by a person skilled in the art to which the present invention belongs.

The ingredients used in the following embodiments are as follows:

Silane coupling agent: Silane coupling agent 550.

### Embodiment 1

This embodiment is a glitter glue stick, which comprises the components with the following weight percentage content:

15% propylene glycol, 30% glycerol, 20% adhesive, 0.3% defoamer, 6% excipient, 1.2% caustic soda, 0.15% preservative, and 3% glitter, with a remaining amount of deionized water;

The adhesive is polyvinylpyrrolidone;

The defoamer is a water-soluble polyether defoamer;

The excipient is a mixed solution of stearic acid and lauric acid in a mass ratio of 2:1;

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 2

This embodiment is a glitter glue stick, which comprises the components with the following weight percentage content:

15% propylene glycol, 30% glycerol, 20% adhesive, 0.3% defoamer, 6% excipient, 1.2% caustic soda, 0.15% preservative, and 5% glitter, with a remaining amount of deionized water;

The adhesive is polyvinylpyrrolidone;

The defoamer is a water-soluble polyether defoamer;

The excipient is a mixed solution of stearic acid and lauric acid in a mass ratio of 2:1;

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 3

This embodiment is a glitter glue stick, which comprises the components with the following weight percentage content:

15% propylene glycol, 30% glycerol, 20% adhesive, 0.3% defoamer, 6% excipient, 1.2% caustic soda, 0.15% preservative, and 5% glitter, with a remaining amount of deionized water;

The adhesive is polyvinylpyrrolidone;

The defoamer is a water-soluble polyether defoamer;

The excipient is a mixed solution of stearic acid and lauric acid in a mass ratio of 7:5

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 4

This embodiment is a glitter glue stick, which comprises the components with the following weight percentage content:

10% propylene glycol, 25% glycerol, 20% adhesive, 0.3% defoamer, 6% excipient, 1.2% caustic soda, 0.15% preservative, and 5% glitter, with a remaining amount of deionized water;

The adhesive is polyvinylpyrrolidone;

The defoamer is a water-soluble polyether defoamer;

The excipient is a mixed solution of stearic acid and lauric acid in a mass ratio of 7:5;

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 5

This embodiment is a glitter glue stick, which comprises the components with the following weight percentage content:

15% propylene glycol, 30% glycerol, 20% adhesive, 0.3% defoamer, 8% excipient, 1.2% caustic soda, 0.15% preservative, 0.1% food color and 3% glitter, with a remaining amount of deionized water;

The adhesive is polyvinylpyrrolidone;

The defoamer is a water-soluble polyether defoamer;

The excipient is a mixed solution of stearic acid and lauric acid in a mass ratio of 2:1;

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 6

This embodiment is a glitter glue stick, which comprises the components with the following weight percentage content:

15% propylene glycol, 30% glycerol, 20% adhesive, 0.3% defoamer, 6% excipient, 1.2% caustic soda, 0.15% preservative, 0.1% food color and 5% glitter, with a remaining amount of deionized water;

The adhesive is polyvinylpyrrolidone;

The defoamer is a water-soluble polyether defoamer;

The excipient is a mixed solution of stearic acid and lauric acid in a mass ratio of 2:1;

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 7

This embodiment is a glitter glue stick, which comprises the components with the following weight percentage content:

15% propylene glycol, 30% glycerol, 20% adhesive, 0.3% defoamer, 6% excipient, 1.2% caustic soda, 0.15% preservative, 0.1% food color and 5% glitter, with a remaining amount of deionized water;

The adhesive is polyvinylpyrrolidone;

The defoamer is a water-soluble polyether defoamer;

The excipient is a mixed solution of stearic acid and lauric acid in a mass ratio of 7:5

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 8

This embodiment is a glitter glue stick, which comprises the components with the following weight percentage content:

8% propylene glycol, 25% glycerol, 20% adhesive, 0.3% defoamer, 6% excipient, 1.2% caustic soda, 0.15% preservative, 0.1% food color and 5% glitter, with a remaining amount of deionized water;

The adhesive is polyvinylpyrrolidone;

The defoamer is a water-soluble polyether defoamer;

The excipient is a mixed solution of stearic acid and lauric acid in a mass ratio of 7:5;

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 9

This embodiment is a glitter glue stick, which comprises the components with the following weight percentage content:

15% propylene glycol, 30% glycerol, 15% adhesive, 0.3% defoamer, 6% excipient, 1.2% caustic soda, 0.15% preservative, 0.1% food color and 5% glitter, with a remaining amount of deionized water;

The adhesive is selected from at least one of polyvinylpyrrolidone, starch and acrylic resin;

The defoamer is a water-soluble polyether defoamer;

The excipient is a mixed solution of stearic acid, palmitic acid and lauric acid;

The preservative is a BIT-type preservative;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Embodiment 10

This embodiment is a glitter glue stick, which comprises the components with the following weight percentage content:

15% propylene glycol, 30% glycerol, 20% adhesive, 0.3% defoamer, 6% excipient, 1.2% caustic soda, 0.15% preservative, 0.1% food color and 5% glitter, with a remaining amount of deionized water;

The adhesive is polyvinylpyrrolidone;

The defoamer is a water-soluble polyether defoamer;

The excipient is a mixed solution of stearic acid, palmitic acid and lauric acid in a mass ratio of 13:22:25;

The preservative is a BIT-type preservative B20;

The preparation method for the glitter glue stick comprises the following steps:

(a) Immerse the glitter in the 1% silane coupling agent solution and remove and dry it for later use; dissolve the caustic soda in partially deionized water to obtain caustic soda solution with a concentration of 20% for later use;

(b) Add the remaining deionized water to the reactor, then add glycerol and propylene glycol sequentially under stirring conditions and stir well to obtain the first mixed solution;

(c) Under stirring conditions, add the adhesive and half of the defoamer to the first mixed solution and continue stirring for 90 min, then heat the mixed solution to 85° C. and continue stirring until the adhesive is completely dissolved. Add the remaining defoamer and stir for 35 min, then add the excipient and stir until they are completely dissolved to obtain the second mixed solution;

(d) Under stirring conditions at 85° C., add the caustic soda solution to the second mixed solution and continue to stir to react for 35 min. After the end of the reaction, under the condition of heat preservation, then add preservatives and stir for 12 min, then add pigments and stir, leave to defoam until the gum becomes colorless or light yellow transparent or translucent liquid, to obtain the third mixed solution;

(e) Add the glitter to the third mixed solution and stir well to obtain the said glitter glue stick.

### Experiment Example 1

Obtain the glitter glue stick prepared in Embodiments 1-10 respectively;

According to the item and method test in the national standard QB/T2857-2007, the pH value, solid content, adhesion, appearance, glittering effect, and coating effect of the glue stick are tested, and the test results are shown in Table 1 and Table 2:

TABLE 1
Glitter glue stick for Embodiments 1-4

| | Embodi- | Embodi- | Embodi- | Embodi- |
|---|---|---|---|---|
| Item | ment 1 | ment 2 | ment 3 | ment 4 |
| PH value | 10.61 | 10.61 | 10.61 | 10.61 |
| Solid | 50 | 52 | 53 | 51 |
| content, % | | | | |
| Adhesion, | 5, broken | 5, broken | 5, broken | 4, broken |
| min | paper | paper | paper | paper |

| | |
|---|---|
| Appearance, | Embodiment 1 < Embodiment 2 < |
| glittering | Embodiment 3 > Embodiment 4 |
| effect | |
| Coating | Embodiment 1 < Embodiment 2 = |
| effect | Embodiment 3 = Embodiment 4 |
| Safety | Comply with the requirements of |
| regulation | 3.1 and 3.2 in QB/T2857-2007 |

TABLE 2
Glitter glue stick for Embodiments 5-10

| Item | Embodiment 5 | Embodiment 6 | Embodiment 7 | Embodiment 8 | Embodiment 9 | Embodiment 10 |
|---|---|---|---|---|---|---|
| PH value | 10.60 | 10.60 | 10.60 | 10.60 | 10.60 | 10.60 |
| Solid | 50 | 53 | 53 | 51 | 48 | 53 |
| content, % | | | | | | |
| Adhesion, | 5, broken | 5, broken | 5, broken | 4, broken | 7, broken | 5, broken |
| min | paper | paper | paper | paper | paper | paper |

| | |
|---|---|
| Appearance, | Embodiment 5 < Embodiment 6 < Embodiment 7 = |
| glittering | Embodiment 9 = Embodiment 10 > Embodiment 8 |
| effect | |
| Coating | Embodiment 5 < Embodiment 6 = Embodiment 7 = |
| effect | Embodiment 9 = Embodiment 10 = Embodiment 8 |
| Safety | Comply with the requirements of 3.1 and 3.2 in QB/T2857-2007 |
| regulation | |

As can be seen from Tables 1 and 2:

The glitter glue stick obtained by the preparation of the present application has excellent adhesion, glittering effect and coating effect.

### Experiment Example 2

Immerse the glitter in the 1% silane coupling agent solution and remove and dry it to obtain the surface-treated glitter; conduct alkali resistance experiments on the surface-treated glitter and the untreated glitter:

The experimental method is as follows:

Prepare an alkaline solution of PH=10+0.2 containing 10% propylene glycol and 10% glycerol, heat to raise the temperature of the alkaline solution to 85° C., add the glitter to be tested and stir well, maintain the temperature at 85° C. so that the glitter is immersed in an alkaline solution at 85° C. for a certain period of time, and test the effect of alkali resistance of the glitter by the length of the immersion time; in comparative tests, the alkali resistance of surface-treated glitter is superior to that of untreated glitter.

Finally, it should be noted that the above embodiments are only used to illustrate the technical solutions of the present invention, not to limit them; although the present invention has been described in detail with reference to the foregoing embodiments, the ordinary technical personnel in the art should understand that it is still possible to make modifications to the technical solutions described in the foregoing embodiments, or to make equivalent replacements for some or all of the technical features therein; and these modifications or replacements do not take the essence of the corresponding technical solutions out of the scope of the technical solutions of the embodiments of the present invention, which shall be covered by the scope of the claims and specification of the present invention.

1. The glitter glue stick is characterized in that it comprises the components with the following weight percentage content:
20%˜60% deionized water, 3%˜20% propylene glycol, 10%˜40% glycerin, 15%˜30% adhesive, 0%˜1% defoamer, 1%˜10% excipient, 0.5%˜2% caustic soda, 0.1%˜0.5% preservative, 0%˜0.3% pigment and 1% ˜10% glitter.

2. The glitter glue stick described in claim 1 is characterized in that the adhesive is selected from at least one of polyvinylpyrrolidone, starch and acrylic resin.

3. The glitter glue stick described in claim 1 is characterized in that the defoamer is a water-soluble polyether defoamer.

4. The glitter glue stick described in claim 1 is characterized in that the excipient is a fatty acid with carbon atom number of 12 to 18.

5. The glitter glue stick described in claim 1 is characterized in that the excipient is a mixed solution of stearic acid, palmitic acid and lauric acid.

6. The glitter glue stick described in claim 1 is characterized in that the preservative is a BIT-type preservative.

7. The preparation method of any of the glitter glue stick described in claim 1 is characterized in that the preparation method comprises the following steps:
(a) Immerse the glitter in the silane coupling agent solution and remove and dry it for later use; dissolve the caustic soda in partially deionized water to obtain caustic soda solution for later use;
(b) Add glycerol and propylene glycol to the remaining deionized water and stir well to obtain the first mixed solution;
(c) Under stirring conditions, add the adhesive and part of the defoamer to the first mixed solution and continue stirring for a certain period of time, then heat the mixed solution and continue stirring until the adhesive is completely dissolved. Then add the remaining defoamer and excipient and stir until they are completely dissolved to obtain the second mixed solution;
(d) Add the caustic soda solution to the second mixed solution for saponification reaction. After the end of the reaction, under the condition of heat preservation, then add the preservatives and pigments in turn and stir well, and leave to defoam, to obtain the third mixed solution;
(e) Add the glitter to the third mixed solution and stir well to obtain the said glitter glue stick.

8. The preparation method described in claim 7 is characterized in that, in step (a), the concentration of the sodium hydroxide solution is 15% to 25%.

9. The preparation method described in claim 7 is characterized in that the heating temperature is 80 to 90° C. in step (c).

10. The preparation method described in claim 1 is characterized in that, in step (d), the saponification reaction by adding sodium hydroxide solution to the second mixed solution includes: adding sodium hydroxide solution to the second mixed solution at 80 to 90° C. under stirring conditions and continuing to stir for 30 to 40 min.
